(19) United States
(12) Patent Application Publication
(10) Pub. No.: US 2004/0151162 A1
(43) Pub. Date: Aug. 5, 2004

(54) Multi-network mobile communication system

(76) Inventor: Kumar Ramaswamy, Plainsboro, NJ (US)

Correspondence Address: Joseph S Tripoli, Thomson Licensing Inc, Patent Department, PO Box 5312, Princeton, NJ, 08543-5312, US

(21) Appl. No.: 10/479,141

(22) PCT Filed: May 30, 2002
(86) PCT No.: PCT/US02/15617

(51) Int. Cl. H04L 12/66; H04L 12/28; H04L 12/56

(52) U.S. Cl. 370/352; 370/401

(57) ABSTRACT

A communication system for communicating via the Internet, includes a portable communications device, and a plurality of networks interconnecting, at least occasionally, the internet with the portable communications device. An intelligent content server is also interconnected to the Internet. A network management entity, is interconnected to the intelligent content server, and chooses which network is to be used for communicating between the intelligent content server and the portable communications device.

### FIELD OF THE INVENTION

The present invention relates generally to mobile communications platforms and more specifically to communications optimization using an intelligent network selection.

### BACKGROUND OF THE INVENTION

Mobile or cellular telephone devices are configured to communicate with a plurality of antennas, either ground or satellite based, which are ultimately connected to the traditional telephone system. Regardless of the specific path used there is a direct link between the cellular telephone and the telephone system communication network. Digital cellular telephone devices are further capable of transmitting to and receiving digital data from a digital data network, such as the Internet, with which the telephone system is interconnected. Such devices have been termed personal communications systems (PCS) devices. Such enhanced PCS devices can request, receive and display information from the internet such as maps, e-mail, text, web pages, audio and video files.

One problem associated with such enhanced capabilities is the bandwidth required to transmit such large volumes of data. Problems with scheduling and routing of data transmissions, as well as inefficient allocation of data transmission capacity, are present in many existing data communications networks. For example, the global interconnection of computer networks known as the Internet routes data packets with the anticipation that the packets will eventually be delivered to the intended receiver but it is not uncommon for packets to be lost or delayed during transmission. Further, the internet does not differentiate between different types of data being transmitted.

Data packets requiring delivery within a certain time frame such as real time audio or video communications receive no preference in transmission over packets that generally do not require a particular time of delivery, such as electronic mail. Data packets carrying important information in which packet loss cannot be tolerated, such as medical images, receive no greater priority than other data packets. Because all data packets are viewed as equally important in terms of allocating transmission resources, less critical transmissions such as e-mail may serve to delay or displace more important and time sensitive data.

Capacity for data transmission in existing data communications networks is often inefficiently allocated. In some instances transmission capacity or bandwidth is allocated to a particular user according to a fixed schedule or particular network architecture, but the available bandwidth is not actually used. In other instances, a user is precluded from transmitting a burst of data that, for the moment, exceeds the user's bandwidth allocation. Existing data communications networks often lack mechanisms whereby bandwidth may be allocated on demand.

The current cellular telephone system uses relatively low bandwidth signaling techniques on the order of fifty kilobits per second. Graphical information such as maps and pictures require relatively wide bandwidths in order to achieve reasonable response times. Video and audio files require even higher bandwidths for adequate response times. With limited spectrum resources, the cost of bandwidth on a relatively narrow band network can be high.

Current television signal broadcasting systems provide relatively wide bandwidth capability on the order of twenty megabits per second for each six megahertz wide television channel. Terrestrial frequency bands in the United States include almost four hundred megahertz of available spectrum. Terrestrial broadcast channels typically have a reception radius of approximately seventy miles, dependent largely on local terrain.

Direct digital satellite television broadcasting systems can also provide digital channels which can be used for digital information transmission. An example of such a system is disclosed in U.S. Pat. No. 6,366,761, entitled PRIORITY BASED BANDWIDTH ALLOCATION AND BANDWIDTH ON DEMAND IN A LOW EARTH ORBIT SATELLITE DATA COMMUNICATIONS NETWORD, issued on Apr. 2, 2002 to Montpetit. Digital data from these channels are receivable over a much wider area typically including tens of thousands of square miles. These channels are not completely used. Thus there is a vast amount of unused television broadcast spectrum available for other uses.

Some data which will be requested by a user of a PCS device will be unique to that user, such as an e-mail addressed only to that user. Other data will be of simultaneous interest to a large number of users, such as weather data or stock market quotations. Other information will be of widespread simultaneous interest only at certain times, such as IRS tax forms during the second week of April. The Internet and the associated IP protocols will be expected to enable the increasing demand for data. Network connectivity can be established through a variety of means including connecting to a broadband modem (cable, DSL or satellite) through wired or wireless means, or by connecting to a nomadic network such as offered by wireless LAN standards, or by connecting to a mobile network. Current bandwidth for cellular telephone devices is barely sufficient to provide unique information to a particular PCS device as such information is requested, and more efficient methods of accessing the appropriate network for the bandwidth actually needed must be found if all of the available bandwidth is not to become exhausted by the increasing number of users.

Within a single network the mechanism or protocol needed to connect to that network in order to obtain a range of services is a straightforward problem with known solutions. However, when one must traverse between different networks the problem of making a seamless transition is substantial. For example, in second generation cellular networks it is often possible to connect to a different network on a per session basis.

Unfortunately, the possibility of optimizing bandwidth at the packet level is not available because the mechanism for communicating across networks has no common protocol layer. In the Internet, the commonly used protocol is termed IPv4 which has a set of tools that enables mobility management. These set of protocols are termed Mobile IP protocols. Several enhancements to the IPv4 protocols have resulted in a second generation termed IPv6. In addition to an expanded address space of 128 bits instead of the 32 bits used by IPv4, there are several features that enable better mobility management. Mobility can be managed by using the static IP addressing schemes in IPv6. In IPv4, due to the scarcity of address space, dynamic and local IP address assignment is often used. The efficiency of address management is expected to be better in IPv6 which will result in better service overall. An example of a mobile system using IPv6 is disclosed in U.S. Pat. No. 6,172,986, entitled MOBILE NODE, MOBILE AGENT AND NETWORK SYSTEM, issued to Watanuki et al. on Jan. 9, 2001.

Data requested by the user may be of a time critical nature and need to be delivered with strict time constraints. Alternatively, data may also be downloaded with less severe time constraints. The former calls for Quality of Service (QoS) constraints that need to be supported by the network. The latter is the typical download model for Internet content and is termed a best-effort delivery. Finally, data may also be delivered with a time delay. Examples could include music or multimedia which the user wishes to view at a later time. This category represents the most flexibility afforded from a network optimization and usage viewpoint.

Given the existence of the many networks, bandwidths and accessibility variables briefly alluded to in the foregoing, a need exists for a mechanism that allows the user to seamlessly roam or transition between these networks, based on a calculation of the needed bandwidth, message priority, and bandwidth cost, such that the minimum required bandwidth at the lowest cost is always selected.

### SUMMARY OF THE INVENTION

In accordance with the principles of the present invention, a communication system for communicating via the Internet, includes a portable communications device, and a plurality of networks interconnecting, at least occasionally, the internet with the portable communications device. An intelligent content server is also interconnected to the Internet. A network management entity, is interconnected to the intelligent content server, and chooses which network is to be used for communicating between the intelligent content server and the portable communications device.

In such a communications system, the problem of optimizing network selection by choosing the most cost effective available bandwidth is addressed by implementing the portable communications device as a portable intelligent multiple network platform. The platform includes multiple front end interfaces, with each interface corresponding to a type of available network, such as a home network interface, broadcast network interface, nomadic network interface and a mobile network interface. The home network interface is typically plugged into a broadband modem, while the other interfaces utilize an antenna terminal to perform wireless communications.

Within the platform each network interface is interconnected to a network data processing layer capable of transmitting and receiving data via either the IPv4 or IPv6 protocol. For large files requiring substantial bandwidths, such as multimedia applications, the network data processing layer is interconnected to a discrete backend applications processor which processes and buffers the data stream.

Each network interface transmits to and receives data from a base station or network termination dedicated to that particular type of network. In turn, each such base station or termination has an appropriate connection to the Internet. Also connected to the Internet is an intelligent content server which is interconnected to a network management entity. In order for the intelligent content server to communicate with the portable intelligent multiple network platform, the platform registers into any of the available networks through any physical layer having a return channel.

The platform can function with the existing mobile IPv4 protocols or can use the static IPv6 global addressing scheme. The platform communicates with the intelligent content server and informs the server of its current IP address and its current specific multi-networking capabilities. The intelligent network management entity chooses the appropriate network to use for each packet which is to be transmitted or received based on optimizing criteria such as priority, desired transmission quality, required bandwidth and cost.

When the portable platform leaves the current network within which it is operating (typically due to physically travelling beyond the range of the current network), the portable platform automatically searches for and tries to connect to the next best (based on the optimization criteria) network. When a new connection is successfully accomplished, the portable platform sends information to the network management entity regarding its current connection. In response to this information, the intelligent network management entity routes subsequent packets through the newer optimum network route. This process can be managed at either a per-packet or per-session level.

### BRIEF DESCRIPTION OF THE DRAWINGS

FIG. 1 is a block diagram illustrating portable communications network selection optimizing system according to the principles of the present invention; and

FIG. 2 is a block diagram of a personal communications system device according to the principles of the present invention, which may be used in the system as illustrated in FIG. 1.

### DETAILED DESCRIPTION OF THE INVENTION

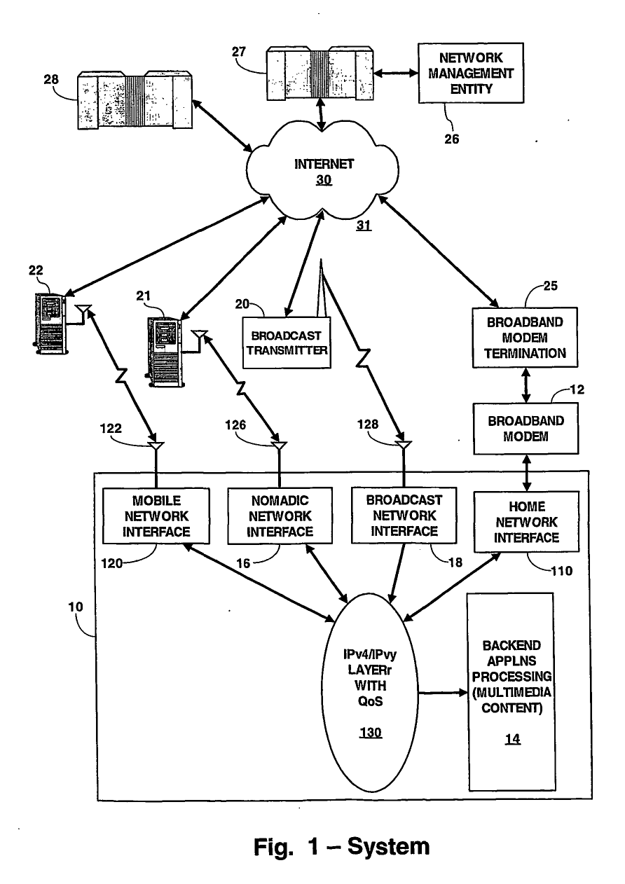

FIG. 1 is a block diagram of a mobile communications system including a multiple network portable platform 10 which is capable of bidirectional transmission and reception with either a broadband modem 12 or with any of a plurality of wireless communications networks via antennas 122, 126 and 128. In practice the antennas 122, 126 and 128 may be a single physical antenna with appropriate matching networks or it may be one or more antennas in close physical proximity. The antenna 122, for example, is responsive to digital cellular telephone signals from, for instance, a cellular telephone mobile network termination or base station 22. The antenna 122 is bidirectionally coupled to a mobile interface circuit 120.

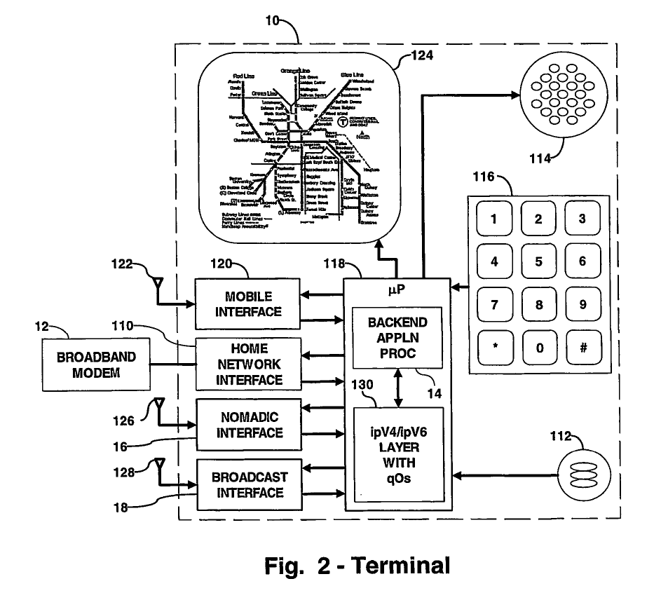

As also seen in FIG. 2, the mobile interface circuit 120 is coupled to a direct data input terminal of a microprocessor 118. A direct data output terminal of the microprocessor (μP) 118 is coupled to an input terminal of the mobile interface 120. An audio output terminal of the microprocessor 118 is coupled to an input terminal of the speaker 114. An output terminal of a microphone 112 is coupled to an audio input terminal of the microprocessor 118. An output terminal of a keypad 116 is coupled to a control input terminal of the microprocessor 118.

The microprocessor operates in a known manner under the control of an application program stored in memory such as a Read Only Memory (ROM) in the microprocessor 118. In particular, the microprocessor is programmed to operate as a data processing layer 130 utilizing the both the current Internet Protocol version 4 (IPv4) and the still developing next generation Internet Protocol version 6 (IPv6). The layer 130 may include a Quality of Service (QoS) program as is well known to those of ordinary skill in this field.

The microprocessor 118 also includes a backend applications processor 14 which is capable of bidirectional communication with the Internet Protocol layer 130. The processor 14 serves as a buffer and decoder for data received by microprocessor 118, and is particularly useful for processing data having a multimedia content such as audio and video files. The backend processor 14 may also be a discrete circuit or combination of integrated circuits that are external to the microprocessor 118 but which are still mounted on the multiple network portable platform 10.

The platform 10, as described above, operates in a known manner to allow a user to make telephone calls. The user manipulates the keys on the keypad 116 to instruct the microprocessor 118 to cause the mobile interface circuit 120 to connect to an external network, such as the Internet 30, or a mobile telephone communications network via the mobile base station 22. The keypad 116 generates dialing tones specifying the desired telephone number or instructional code. Alternatively, signals may be received from the Internet 30 or from the cellular telephone network indicating that someone is attempting to call the portable platform 10. In response to these signals, the microprocessor 118 conditions the mobile interface circuit 120 to connect to the network and complete the call.

In either event, signals representing spoken information from the microphone 112 are digitized by the microprocessor 118, and the digitized signal is transmitted through the mobile interface 120 and the antenna 122 to the mobile network base station 22. Simultaneously, signals received by the antenna 122 from the base station 22, and representing received digitized speech information from the other party, are received by the mobile interface 120, converted to a sound signal by the microprocessor 118 and supplied to the speaker 114.

As described above, the multiple network platform 10 also provides the capability of requesting and receiving information from a computer, typically via the internet. Data representing requested information may be generated by the user from the keypad 116, which may have more keys than illustrated in FIG. 2. The information request is supplied by the microprocessor 118 to any of the network interfaces available on the network platform 10. For example, the platform 10 may include not only a mobile interface 120, but also a home network interface 110, a nomadic network interface 16, and a broadcast network interface 18. Depending on which network is available for use, the information request is transferred to either a broadband modem 12 or one of the antennas 122, 126 or 128.

Regardless of the network in use at a particular time, the information request is transmitted to the Internet 30. Also supplied by the common layer 130 is a status report regarding which of the network interfaces 16, 18, 110 and 120 is currently in communication with its associated network. Each of these networks will have unique characteristics associated with its particular network path. These characteristics will include the bandwidth of the network path, the monetary cost of using the network, the data transmission speed available, the quality and reliability of the network, the geographic coverage of the network and the type of data best suited for transmission via the particular network path. By transmitting the current universe of network availability, a recipient may be able to select the most appropriate network for transmission of return data.

The information transmitted by platform 10 to the Internet 30 will be received by a server machine such as intelligent content server 27 which contains the information desired by the user of the portable platform 10. Interconnected to the content server 27 is a network management entity 26 which receives the network availability or status report from platform 10. The management entity 26 is programmed to optimize the selection of the network via which its associated content server 27 will transmit and receive data to and from the platform 10.

There exist two possible modes of transmitting the desired information from the server 27. The first mode is a unicast mode in which the server's data is intended only for a specific user's platform 10. The second possible mode is a multicast mode in which the server's data is intended for simultaneous transmission to a plurality of platforms 10.

In either case the objective of the server 27 is to transport P packets to the platform 10 by routing the data through the backbone or internal structure of the internet 30 to the “edge” 31 of its global computer network, and to continue the data transmission from the edge 31 across the chosen communications access network 20, 21, 22 and/or 25 to the platform 10.

In order for the network management entity 26 to optimize its choice of a particular network from the universe of available networks, the goal for the unicast mode is to minimize the expression:

$${Minimize}_{j} [ {P}_{j} {\sum }_{i} ( ( {x}_{i} + {y}_{i} ) {N}_{i} ) ] subject to {\sum }_{j} {P}_{j} = P$$

where

xᵢ is the cost of transporting each data packet through the internet 30 to its edge 31 for the ith access line;

yᵢ is the cost of transporting each packet through the respective access networks, e.g. 20, 21, 22, 25;

Pⱼ is the number of packets transported on link i; and

Nᵢ is the number of users on the ith link requesting the content of server 27.

The unicast expression can be solved as an optimization problem using standard optimization techniques, which will result in reducing the cost of transporting each packet through the entire network, that is, through the internet 30 and through the following communications network 20, 21, 22 or 25. To enable quality of service, the cost structure for each segment, xᵢ and yᵢ used earlier are appropriately reflected and the optimization problem is solved with the new numbers.

For the multicast case, the goal is to minimize the following expression:

$${Minimize}_{j} [ {P}_{j} {\sum }_{i} ( {x}_{i} + {y}_{i} ) ] subject to {\sum }_{j} {P}_{j} = P$$

This expression is identical to the unicast mode except that the penalty incurred for multiple users requesting server content (Nᵢ) is removed. This expression also can be optimized using well known optimization techniques. Each optimization may be performed on either a per packet or per session basis.

1. A communication system for communicating via the Internet, comprising:
a portable communications device;
a plurality of networks, each network interconnecting, at least occasionally, the internet with the portable communications device;
an intelligent content server, the content server being interconnected to the Internet; and
a network management entity, the network management entity being interconnected to the intelligent content server, the network management entity choosing which network is to be used for communicating between the intelligent content server and the portable communications device.

2 The communications system of claim 1, wherein the portable communications device comprises a plurality of network interfaces for establishing a communications link with each of the plurality of networks, respectively.

3. The communications system of claim 2, wherein the portable communications device further comprises a microprocessor programmed to process data via any of the network interfaces.

4. The communications system of claim 3, wherein the network management entity is programmed to choose the network to be used for communicating with the portable device based on available bandwidth of each of the plurality of networks.

5. The communications system of claim 4, wherein the network management entity evaluates a cost associated with each network when choosing the network to be used for communicating with the portable communications device.

6. The communications system of claim 5, wherein the network management entity evaluates a quality-of-transmission value associated with each network when choosing the network to be used for communicating with the portable communications device.

7. The communications system of claim 6, wherein the network management entity evaluates the network to be used for communicating with the portable communications device for each data packet to be transmitted between the intelligent content server and the portable communications device.

8. The communications system of claim 6, wherein the network management entity evaluates the network to be used for communicating with the portable communications device for each data transmission session.

9. The communications system of claim 8, wherein the microprocessor is programmed to transmit all information to and from each network interface by using a common Internet protocol layer.

10. The communications system of claim 9, wherein the microprocessor is programmed:
to determine which of the plurality of networks is operational;
to transmit information representing which of the plurality of networks is operational to the network management entity.

11. A data transmission optimization system for use in multi-network environments, comprising:
an intelligent content source (27);
an intelligent network management entity (26) interconnected to the intelligent content source;
a multi-network platform (10) interconnected to a plurality of communications networks, the multi-network platform transmitting a communications network status report to the intelligent management entity, the intelligent management entity selecting a communications network (20, 21, 22, 25) for transmission of data from the intelligent content source to the multi-network platform.

12. The data transmission optimization system of claim 11 wherein the intelligent management entity selects one of the communications networks based on an optimization algorithm that includes network bandwidth as a variable.

13. The data transmission optimization system of claim 11 wherein the optimization algorithm evaluates network cost of data transmission as a variable.

14. The data transmission optimization system of claim 11 wherein the optimization algorithm evaluates network quality of data transmission as a variable.

15. The data transmission optimization system of claim 11 wherein the intelligent management entity selects one the communications networks for each data transmission session with the multi-network platform.

16. The data transmission optimization system of claim 11 wherein the intelligent management entity selects one of the communications networks for each data packet transmitted to the multi-network platform.

17. A method of optimizing data transmission between a portable platform and an intelligent content server by optimizing a communications network selection in a multi-network environment, comprising the steps of:
determining which communications networks are connected to the portable platform;
transmitting a communications network status report to the intelligent content server;
causing a network management entity to evaluate characteristics of the communications networks connected to the portable platform; and
causing the network management entity to select a communications network based on the evaluated characteristics; and
transmitting data from the intelligent content server to the portable platform via the selected communications network.

18. The method of claim 17, further comprising the step of evaluating characteristics of the communications networks for each data transmission session.

19. The method of claim 17, further comprising the step of evaluating characteristics of the communications networks for each data packet to be transmitted.

20. The method of claim 17, wherein data is transmitted from the intelligent content server to the portable platform via a common internet protocol layer
